(19) United States
(12) Patent Application Publication
(10) Pub. No.: US 2011/0107116 A1
(43) Pub. Date: May 5, 2011

(54) System and Method for Power Over Ethernet Enabled Network Management

(75) Inventors: Wael William Diab, San Francisco, CA (US); Nicholas Ilyadis, Irvine, CA (US)

(73) Assignee: Broadcom Corporation, Irvine, CA (US)

(21) Appl. No.: 12/612,239

(22) Filed: Nov. 4, 2009

(51) Int. Cl. G06F 1/26

(52) U.S. Cl. 713/300

(57) ABSTRACT

A system and method for power over Ethernet enabled network management. An intermediary device is positioned between a computing device and a network. The intermediary device can be designed to wake up a part of the computing device (e.g., network interface) through the application of power via power over Ethernet. The transition of the part of the computing device from a sleep state to an active state can facilitate the further initiation of a management function. For example, the transition of a network interface of the computing device from a sleep state to an active state can facilitate the processing of a wake on LAN message, retrieval of information, maintenance, or other communication need.

### BACKGROUND

1. Field of the Invention

The present invention relates generally to network management and, more particularly, to a system and method for power over Ethernet enabled network management.

2. Introduction

Energy costs continue to escalate in a trend that has accelerated in recent years. Such being the case, various industries have become increasingly sensitive to the impact of those rising costs. One area that has drawn increasing scrutiny is the IT infrastructure. Many companies are now looking at their IT systems' power usage to determine whether the energy costs can be reduced. For this reason, an industry focus on energy efficient networks has arisen to address the rising costs of IT equipment usage as a whole (i.e., computing devices, displays, printers, servers, network equipment, etc.).

One area in which energy savings can be realized is in the various energy states that can be defined for all or part of a system (e.g., computing device). One example of such an energy state is a sleep state. For example, a sleep state can be entered autonomously by a computing device.

A computing device that has entered into a sleep state can be awoken by a user at the computing device, or can be awoken remotely. To facilitate a remote wake up, the computing device can keep the network interface portion of the computing device in an active state. The power consumed by the network interface portion of the computing device is presumed to be relatively low as compared to the power consumed by the computing device in an active state.

Having the network interface portion of the computing device remain powered while the computing device enters into a sleep state facilitates a wake on LAN (WoL) feature. This WoL feature is based on the detection by the network interface portion of the computing device of the receipt of a “magic packet” that can include a remote wake-up instruction. Detection of such a remote wake-up instruction by the network interface portion of the computing device can be used as a trigger to transition the computing device to an active state from the sleep state.

The WoL feature facilitates energy savings without compromising remote network administration. What is needed, however, is a mechanism that further improves energy savings in the computing device itself while expanding the administration of such computing devices.

### SUMMARY

A system and/or method for power over Ethernet enabled network management, substantially as shown in and/or described in connection with at least one of the figures, as set forth more completely in the claims.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates an example of a network environment.

FIG. 2 illustrates an embodiment of a computing device.

FIG. 3 illustrates an embodiment of device that enables switching.

FIG. 4 illustrates an embodiment of a PoE system.

FIG. 5 illustrates a flowchart of a process of the present invention.

FIG. 6 illustrates an embodiment of a PoE system that is used for activation of a network interface portion of a computing device.

### DETAILED DESCRIPTION

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

Computing devices can enter into a sleep state autonomously. When a computing device goes into a sleep state (e.g., standby or hibernate state), the computing device itself can save considerable power by powering down the CPU(s), display, and most other peripherals. A computing device that enters into a sleep state can have WoL enabled. As noted, the WoL function enables the waking of the computing device remotely over a network connection. With WoL enabled, power is reserved for the network interface device, which can be designed to listen for a specific packet (i.e., “magic packet”) or other WoL recognized pattern. When the computing device validates the receipt of a magic packet, the network interface device turns on the computing device to a full operational state.

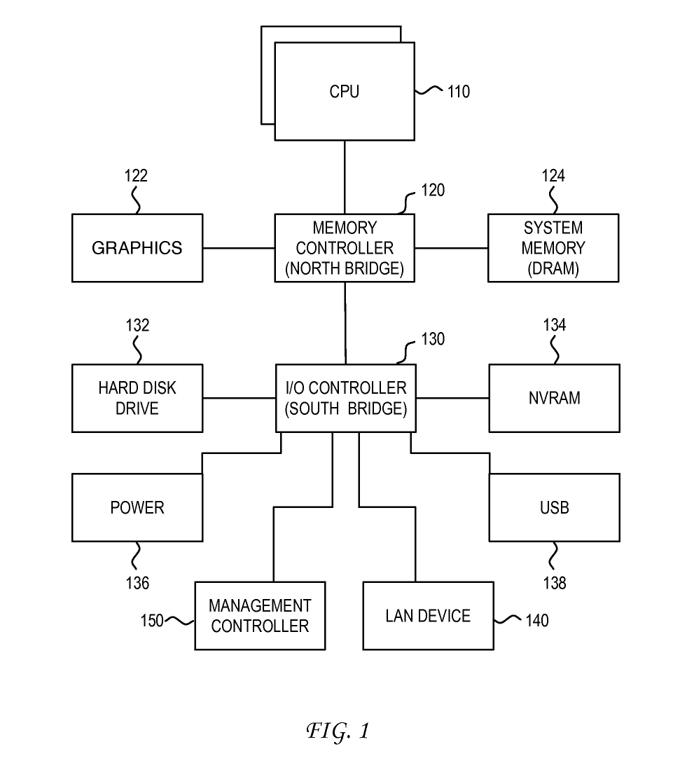

FIG. 1 illustrates an example embodiment of a computing device. As illustrated, a computing device includes conventional computing components such as CPU(s) 110, memory controller (north bridge) 120, and I/O controller (south bridge) 130. As illustrated, memory controller 120 can be coupled to graphics subsystem 122 and main system memory 124. I/O controller 130, on the other hand, can also be coupled to various components, including hard disk drive 132, nonvolatile RAM (NVRAM) 134, power subsystem 136 and USB controller 138. As would be appreciated, the example embodiment of FIG. 1 is not intended to be exhaustive or limiting. Various other memory controller and I/O controller configurations can be used with the principles of the present invention.

As FIG. 1 further illustrates, I/O controller 130 is also in communication with LAN device 140. In general, LAN device 140 provides networking functionality onto the motherboard, thereby eliminating the need for an add-in network interface card (NIC). In one embodiment, LAN device 140 includes a fully integrated 10/100/1000BASE-T Gigabit Ethernet media access controller (MAC), PCI Express bus interface, on-chip buffer memory, and integrated physical layer (PHY) transceiver in a single-chip solution. In other embodiments, the PHY may not be integrated such as when initially supporting higher-end PHYs (e.g., 10GBASE-T). In other embodiments, LAN device 140 can also include a wireless communication component.

In one embodiment, LAN device 140 (possibly with an integrated management controller) can also be used in an OS-absent environment (with CPU(s), chipset, and system memory powered down) to run offline applications. In various embodiments, the management controller is a discrete device such as that illustrated in FIG. 1, or can be integrated with memory controller 120, I/O controller 130, LAN device 140, etc. As noted, IT administrators can communicate with LAN device 140 even when the computing device's OS is hibernating. For example, the IT administrator can perform an upgrade or other management to the computing device through a request on WoL event through LAN device 140.

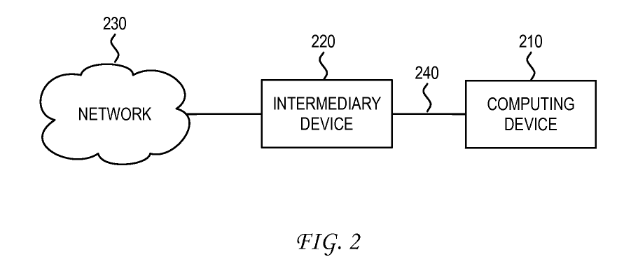

FIG. 2 illustrates an example network environment in which a computing device can reside. As illustrated, computing device 210 can be coupled to intermediary (or switching) device 220. Intermediary device 220 in turn is coupled to network 230 such as an intranet or wide area network. In one function, intermediary device 220 can be designed to facilitate a connection by computing device 210 to network 230. In various examples, intermediary device 220 can be embodied as a switch, a voice over IP (VoIP) phone platform, or the like.

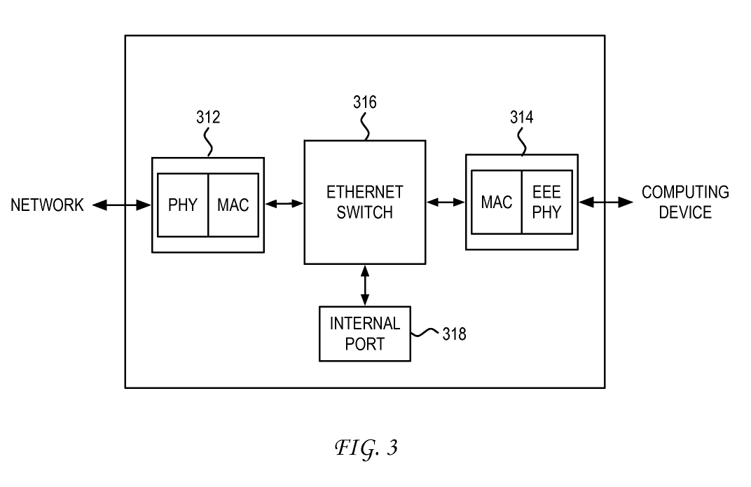

An embodiment of intermediary device 220 is illustrated in FIG. 3. As illustrated, the intermediary device includes at least two Ethernet ports 312, 314 and internal port 318. Ethernet ports 312, 314 and internal port 318 support full duplex links such that traffic can be coming from either direction at the same time. Traffic can also be switched to two ports simultaneously. For example, internal port 318 can add traffic to either or both of Ethernet ports 312, 314, or receive traffic from either or both of Ethernet ports 312, 314. Ethernet ports 312, 314 and internal port 318 are coupled together via switch 316. As would be appreciated, Ethernet ports 312, 314 can be enabled using media access control (MAC) and PHY interfaces.

As noted above, the computing device can be designed to enter a sleep state with WoL enabled such that the network interface portion of the computing device remains powered. This powering enables the network interface portion of the computing device to listen for the magic packet that can initiate a wake up of the computing device. While the power consumed by the network interface portion of the computing device is certainly less than the entire system, further power savings are still achievable.

It is therefore a feature of the present invention that further power savings can be achieved by also powering down the network interface portion of the computing device during a WoL enabled sleep state. It is recognized that powering down the network interface portion of the computing device would appear to compromise the remote management of the computing device as the network interface portion of the computing device would be unable to respond to messages (e.g., magic packets) while the computing device remained in a sleep state. In accordance with the present invention, the network interface portion of the computing device can be activated by the intermediary device, which acts as a power over Ethernet (PoE) power sourcing equipment (PSE).

In general, the intermediary device, which incorporates such PSE functionality, can be designed to monitor traffic destined for the computing device. In this way, the intermediary device can act as a WoL proxy for the computing device. Here, the intermediary device would discard (not forward) any non-WoL packets addressed for the computing device, and would seek to wake-up the network interface portion of the computing device when a magic packet directed to the computing device is detected by the intermediary device. In accordance with the present invention, the wake-up of the network interface portion of the computing device can be enabled through the powering of the network interface portion of the computing device over the network link. In other words, the network interface portion of the computing device can represent a PoE powered device (PD) type device that is powered by the intermediary device operating as a PoE PSE. As will be described in greater detail below, after the network interface portion of the computing device is activated through the provision of power over the network link, the magic packet can then be forwarded to the network interface portion of the computing device to facilitate a wake up of the computing device.

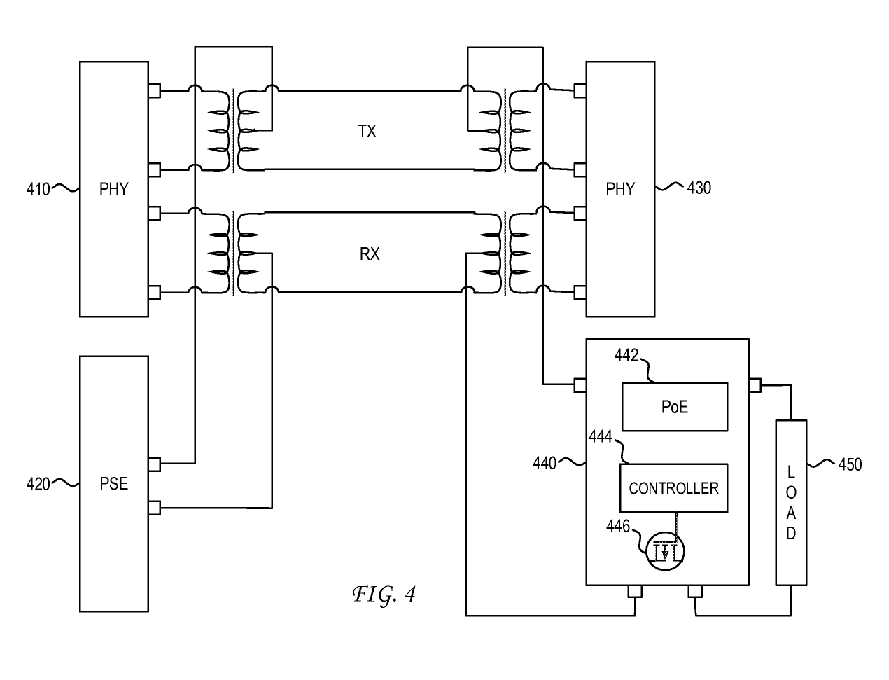

FIG. 4 illustrates an example framework of a PoE system. As illustrated, the PoE system includes an intermediary device that transmits power to PD 440 over two wire pairs. Power delivered by PSE 420 to PD 440 is provided through the application of a voltage across the center taps of a first transformer that is coupled to a transmit (TX) wire pair and a second transformer that is coupled to a receive (RX) wire pair carried within an Ethernet cable. In general, the TX/RX pairs can be found in, but not limited to structured cabling. The two TX and RX pairs enable data communication between Ethernet PHYs 410 and 430 in accordance with 10BASE-T, 100BASE-TX, 1000BASE-T, 10GBASE-T and/or any other Layer 2 PHY technology.

As is further illustrated in FIG. 4, PD 440 includes PoE module 442. PoE module 442 includes the electronics that would enable PD 440 to communicate with PSE 420 in accordance with a PoE specification such as IEEE 802.3af (PoE), 802.3 at (PoE Plus), legacy PoE transmission, or any other type of PoE transmission. PD 440 also includes controller 444 (e.g., pulse width modulation (PWM) DC:DC controller) that controls power transistor (e.g., FET) 446, which in turn provides constant power to load 450.

An advantage of combining a PoE capable intermediary device (e.g., switch) with a computing device operating as a PD is the ability to monitor connectivity between the intermediary device and the computing device when the network interface portion of computing device is powered down. Where the computing device is completely powered down, the computing device operating as a PD can be detected by the PSE through the PD's signature resistance even though power has not been applied over the network link. This is in contrast to a non-PoE framework where it would be impossible to distinguish between a computing device that has failed and a computing device that has been disconnected. Maintaining proper visibility into the connectivity of computing devices to the network improves security from the perspective of an enterprise's management of assets.

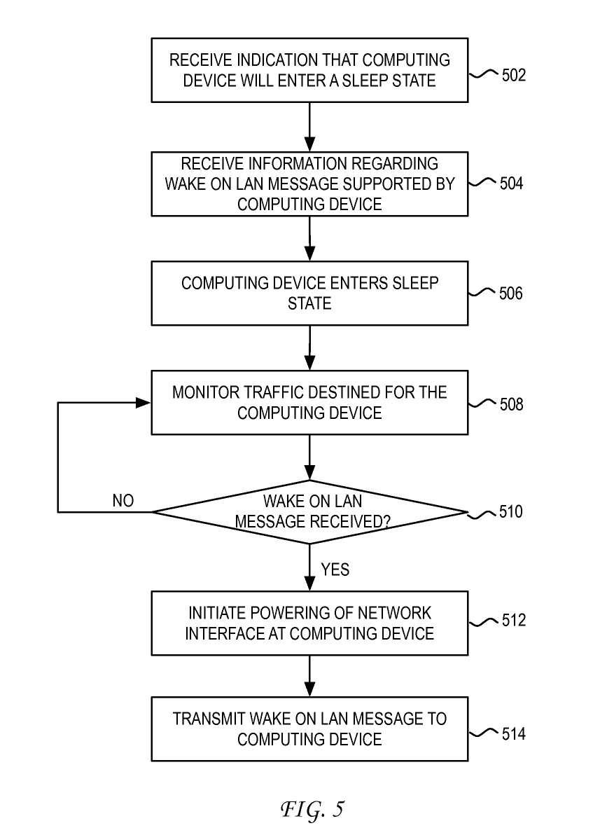

To further illustrate the features of the present invention, reference is now made to the flowchart of FIG. 5. As illustrated, the process begins at step 502 where the intermediary device receives an indication from the computing device that the computing device is in the process of entering a WoL enabled sleep (or low power) state. This received indication can be in response to the autonomous action that is taken by the computing device in entering the sleep state. In one scenario, the entering by the computing device into a sleep state can be based on the remote action taken by a network management station. In this scenario, the indication that the computing device has entered into a sleep state can be received by the intermediary device from either the computing device or from the network. In general, the source of the sleep-state indication would be implementation dependent and would not detract from the principles of the present invention.

At step 504, the intermediary device would then receive information regarding the type of WoL message that is supported by the computing device. In one embodiment, the WoL message information is received together with the received indication of step 502. In another embodiment, the WoL message information is received in a separate communication that can occur before or after the received indication of step 502. Of course, if the WoL message information represents a standardized message, then the WoL message information receiving of step 504 can be an optional step. It should also be noted that the source of the WoL message information can be the computing device as well as the network. In general, the source and timing of receipt of the information passed in steps 502 and 504 would depend on the implementation of the computing device as well as the management of the computing device.

At step 506, the computing device enters into a sleep state. Unlike conventional WoL enabled sleep states, the sleep state entered at step 506 includes an entry by network interface portion of the computing device into a sleep state that awaits activation via the power delivered by the intermediary device over the network cabling.

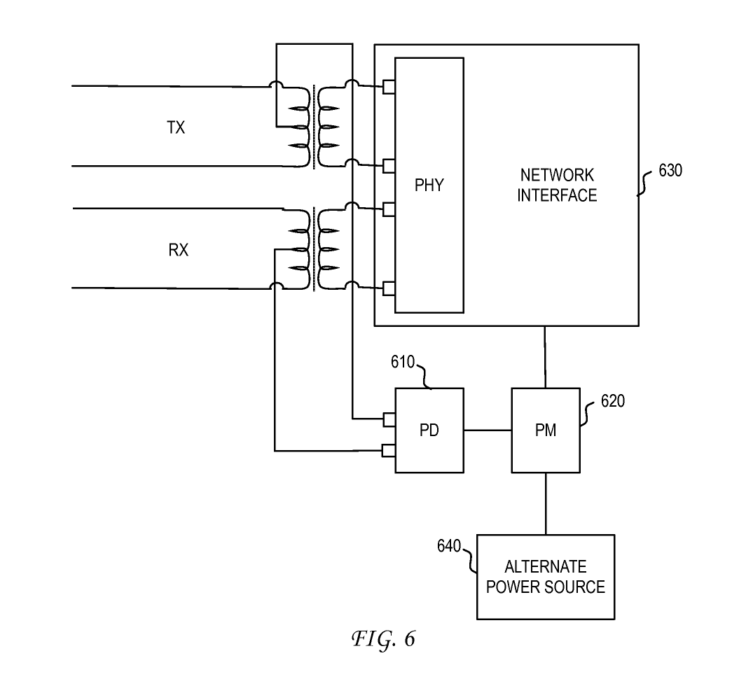

FIG. 6 illustrates an example configuration of the computing device that enables activation of the network interface portion of the computing device via the power delivered by the intermediary device. As illustrated, PD 610 is designed to extract power from a network cable. The extracted power can be provided to a power management (PM) module 620 that is designed to deliver power to network interface 630. In a WoL enabled sleep state, PM module 620 can be designed to deliver power to network interface 630 only when its source is PD 610. In an alternative usage scenario, PM module 620 can be designed to power network interface via alternate power source 640 (e.g., battery or AC outlet).

As would be appreciated, PM module 620 can also be designed to support a WoL enabled sleep state where network interface 630 remains powered. This would represent the scenario where the intermediary device could not function as a PSE. In this scenario, network interface 630 would be powered via alternate power source 640.

During the WoL enabled sleep state, PD 610 can be maintained in any one of a variety of operating states. For example, PD 610 can be designed to be maintained in any one of a pre-detection state, post-detection state, pre-classification state, post-classification state, or pre-power application state. This can be the case because PD 610 may not be used for any other function other than to power network interface 630, and may therefore be maintained in a state that can lead to a quick transition to a state of power application. As would be appreciated, the state in which PD 610 is maintained would be implementation dependent. Here, the choice of state can be influenced by such factors as the amount of power needed to maintain such state, the power request/priority or reservation protocol implemented by the PSE and PD module, the time to transition to the active use of network interface 630, etc.

While the computing device is in a sleep state and the network interface portion is also powered down, the intermediary device would monitor, at step 508, the traffic destined for the computing device to determine whether a WoL message has been received. This monitoring can be designed to identify a WoL message that the intermediary device was previously made aware of with regard to the computing device. In one embodiment, intermediary device can be designed to match the traffic to a WoL filter. In one embodiment, the intermediary device can produce additional energy savings during this time through the powering down of its client interface that support the computing device.

At step 510, the intermediary device continues to monitor traffic destined for the computing device to determine whether a WoL message is received. This process will continue indefinitely until such a WoL message is determined to have been received. The intermediary device will discard any non-WoL packets received from the network that would otherwise have been forwarded to the computing device (except, for example, address resolution protocol (ARP) requests, which the intermediary device could also provide a proxy response for).

When it is determined at step 510 that a WoL message has been received for the computing device, the process then continues to step 512 where the intermediary device initiated the deliver of power to the network interface at the computing device. As noted, the particular state in which the PSE and PD were maintained during the sleep state of the computing device would be implementation dependent. An advantage of that state being a post-detection state would facilitate the intermediary device's detection of a disconnection from the network cable. This would facilitate the generation of an alert for management purposes. In one embodiment, a local management register can be set, which can be read by, for example, using the Simple Network Management Protocol (SNMP).

In one embodiment, the intermediary device can also be designed to support encrypted WoL messaging. This ensures that the powering of the network interface portion of the computing device is conditioned on some form of authentication. This improves the security of such network management and is in contrast to conventional WoL messages that are open or unencrypted.

Regardless of the particular state in which the PSE and PD were maintained, the process of step 512 is designed to bring the network interface portion of the computing device to an actively powered state. As would be appreciated, the length of time needed to properly transition the network interface portion to an active state would be implementation dependent. Such a length of time can be further accommodated by suitable buffering built into the intermediary device.

Once the network interface portion of the computing device has competed its transition to an active state, the intermediary device can then forward the WoL message to the computing device at step 514. Receipt of such a WoL message by the network interface portion would trigger a transition of the computing device from a sleep state to an active state to receive additional communication from the network.

It should be noted that while the above description has focused on a WoL application, the principles of the present invention are not restricted to such a WoL application. The principles of the present invention can be used to enhance WoL or can be used without WoL. Indeed, the principles of the present invention can be applied to the powering of any interface for a management purpose.

For example, the principles of the present invention can be used where the network interface portion of a non-WoL computing device (e.g., laptop, desktop, kiosk, etc.) is switched off during certain time periods (e.g., nights, weekends, or the like) and turned on for system maintenance.

As the principles of the present invention provide further power saving benefits to a device entering a sleep state, the principles of the present invention can be used with a proxy mechanism for such a device where a network interface portion of the device is kept alive for a particular function. For example, the network interface portion may be kept alive to enable pinging of the device, querying certain information, etc.

It should also be noted that the principles of the present invention can be applied to various EEE control policies, regardless of the particular implementation in the stack. Further, it should be noted that the principles of the present invention are not dependent on the particular communication protocol across the link. Any communication protocol that can advertise parameters associated with WoL states can be used.

As would be appreciated, the principles of the present invention can be used with various port types (e.g., backplane, twisted pair, optical, etc.) as well as standard or non-standard (e.g., 2.5G, 5G, 10G, 20G, 25G, 28G, etc.) link rates, as well as future link rates (e.g., 40G, 100G, etc.). The principles of the present invention can also be used with BroadReach Ethernet applications that are applied to Ethernet links greater than 100 meters (e.g., 500 meters) as well as various types of PoE systems such as single-pair, two-pair and four-pair PoE systems.

These and other aspects of the present invention will become apparent to those skilled in the art by a review of the preceding detailed description. Although a number of salient features of the present invention have been described above, the invention is capable of other embodiments and of being practiced and carried out in various ways that would be apparent to one of ordinary skill in the art after reading the disclosed invention, therefore the above description should not be considered to be exclusive of these other embodiments. Also, it is to be understood that the phraseology and terminology employed herein are for the purposes of description and should not be regarded as limiting.

What is claimed is:

1. A method in an intermediary device that resides between a computing device and a network, comprising:
receiving information from said computing device via a network cable, said received information providing an indication to said intermediary device of an entry by said computing device into a sleep state;
monitoring communication received from said network that is destined for said computing device;
while said computing device is in said sleep state, determining whether said received communication includes a message intended for said computing device; and
transmitting power over said network cable to power at least part of said computing device when it is determined that said communication includes a message that is intended for said computing device, said transmitted power enabling said computing device to transition out of said sleep state.

2. The method of claim 1, wherein said receiving comprises receiving information regarding a type of wake on LAN pattern.

3. The method of claim 1, wherein said determining comprises determining whether said message is a wake on LAN message.

4. The method of claim 1, wherein said transmitting comprises transmitting power over said network cable to awaken a network interface card of said computing device.

5. The method of claim 1, wherein the Ethernet method is implemented in a voice over IP phone.

6. The method of claim 1, further comprising discarding said communication if it is determined that it does not include a message that can awaken said computing device.

7. A method in an intermediary device that resides between a computing device and a network, comprising:
receiving information from said computing device via a network cable, said received information providing an indication to said intermediary device of an entry by said computing device into a sleep state;
transitioning, in response to said received indication, a network interface that supports said computing device from an active state to an energy saving state;
transitioning said network interface from said energy saving state to said active state after it is determined that a communication to awaken said computing device from said sleep state is received from said network; and
transmitting power over said network cable to power at least part of said computing device after it is determined that a communication to awaken said computing device from said sleep state is received from said network, said transmitted power enabling said computing device to transition out of said sleep state.

8. The method of claim 7, further comprising receiving information regarding a wake on LAN pattern.

9. The method of claim 7, wherein said transitioning said network interface comprises transitioning said network interface from said energy saving state to said active state after it is determined that a wake on LAN packet is received from said network.

10. The method of claim 7, wherein said transmitting comprises transmitting power over said network cable after it is determined that a wake on LAN packet is received from said network.

11. The method of claim 7, further comprising forwarding said received message to said computing device.

12. An Ethernet device, comprising
a first network interface that communicates with a network device;
a second network interface that communicates with a computing device, said second network interface entering an energy saving state when said computing device enters into a sleep state; and
a controller that monitors said first network interface, while said computing device is in said sleep state, for a communication that includes a message that can awaken said computing device from said sleep state, wherein upon detection of said message, said controller initiates a transmission of power from a power supply to said computing device via said second network interface, said transmitted power enabling said computing device to transition out of said sleep state.

13. The device of claim 12, wherein said Ethernet device is a voice over IP phone.

14. The device of claim 12, wherein said message is a wake on LAN message.

15. The device of claim 12, wherein said transmitted power enables a network interface card in said computing device to awaken.

16. The device of claim 12, wherein said transmitted power enables a network interface card in said computing device to receive said message that is forwarded to said second network interface.

17. A method in an Ethernet device, comprising:
receiving information from a remote device via a network cable, said received information providing an indication to said Ethernet device of an entry by said remote device into a sleep state;
while said remote device is in said sleep state, identifying a need to communicate with said remote device; and
transmitting power over said network cable to power at least part of said remote device when said need is identified, said transmitted power enabling at least said part of said remote device to transition out of said sleep state to respond to said identified need.

18. The method of claim 17, wherein said identified need is a receipt, by said Ethernet device, of a wake on LAN message intended for said remote device.

19. The method of claim 17, wherein said identified need is a need to retrieve information from said remote device.

20. The method of claim 17, wherein said identified need is to perform maintenance on said remote device.
